(19) United States
(12) Patent Application Publication
(10) Pub. No.: US 2001/0022884 A1
(43) Pub. Date: Sep. 20, 2001

(54) C-band multimode cladding optical fiber amplifier

(76) Inventors: Dominique Bayart, Clamart (FR); Philippe Bousselet, Leudeville (FR); Florence Leplingard, Versailles (FR); Laurence Lorcy, St Fargeau Ponthierry (FR); Laurent Gasca, Villebon Sur Yvette (FR)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/796,653

(22) Filed: Mar. 2, 2001

(30) Foreign Application Priority Data
Mar. 3, 2000 (FR) 00 02 752

(51) Int. Cl. G02B 6/02

(52) U.S. Cl. 385/123

(57) ABSTRACT

A C-band optical amplifier includes a fiber with a monomode core, a multimode internal cladding and an external cladding. It further includes a pump for pumping the fiber. The fiber is not doped with ytterbium and the multimode cladding has a diameter less than 55 μm. The amplifier can be used for amplifying C-band signals in wavelength division multiplex transmission systems.

### BACKGROUND OF THE INVENTION

1. Field of the invention

The present invention relates to optical amplification and more specifically to amplification by pumping doped fibers.

2. Description of the prior art

Many transmission system amplifiers and repeaters amplify the signals transmitted by pumping in an erbium-doped optical fiber. Amplification is based on absorption by the pump of ions from the fiber dopant and a transfer of energy from the dopant ions to the signals passing through the fiber. In this context, the expression “population inversion ratio” refers to the proportion of dopant ions in the excited state. Erbium has a natural gain band with a high inversion ratio around 1530 nm to 1560 nm; it also has a gain band with a lower inversion ratio around 1570 nm to 1600 nm.

The emergence of wavelength division multiplex transmission systems has necessitated an increased bandwidth, in order to increase the number of channels, and an increased gain throughout the available bandwidth. Various bands are used in optical fiber transmission systems. The expression “C band” refers to the range of wavelengths from 1529 nm to 1565 nm and the expression “L band” refers to the range of wavelengths from 1569 nm to 1603 nm. More generally, different values, above 1565 nm, can be considered for the L band, over a bandwidth of the order of 30 nm or 35 nm.

The power of the pump injected into the doped fiber can be increased to increase the gain. This approach is limited by the power of the pumps and by the efficiency of the transfer of power into the doped fiber. Another solution is to increase the number of pumps, which has cost and overall size drawbacks.

An optical fiber having a multimode internal cladding and a core has been proposed for pumping. The expressions “double core fiber” and “multimode core fiber” are used interchangeably in respect of such fibers. This technique uses wide stripe pumps with higher powers. Powers of a few watts are possible, compared to the powers of only a few hundreds of milliwatts for the conventional amplifier pumps referred to above.

EP-A-0 723 714 proposes using a multimode optical fiber for pumping which has a codoped monomode core, a multimode internal cladding and an external cladding. Multimode pumping means nm are coupled optically into the internal cladding; the monomode core codoped with ytterbium and erbium to encourage the transfer of energy from the pump of the ytterbium to the erbium; ytterbium has a very high absorption peak at around 975 nm.

U.S. Pat. application Ser. No. 09/673,183 proposes an optical amplifier for the L band using an optical fiber with a multimode internal cladding and low population inversion in the core; it indicates that the fiber can be a fiber codoped with ytterbium and erbium provided that the population inversion remains low.

R. Sugimoto et al, in an article entitled “High power double band EDFA with simple configuration”, ECOC'99, 1-276 to 1-277, propose an amplifier for the C and L bands. The first stage of amplification includes two single cladding amplifier fibers respectively pumped by pumps at 980 nm and 1480 nm; the C and L bands are amplified in this first stage; the second stage is dedicated to L band amplification and includes a double cladding fiber which is doped with erbium only in the fiber core. The fiber core has a diameter of 5 μm and the multimode cladding has an outside diameter of 50 μm.

The previous two documents use for amplification in the L band the gain band of erbium around 1570 nm to 1600 nm, which represents a lower inversion ratio than the absorption band from 1530 nm to 1560 nm. Amplifiers with a longer fiber are therefore used.

The invention relates to the problem of optical amplification in the C band. It proposes a solution that enables the use of multimode core fibers and wide stripe pumps. The invention goes against the prejudice that codoping with ytterbium is necessary to transfer power from the pump to the erbium ions. One problem of the codoping technique is that doping with ytterbium is generally accompanied by doping with phosphorus to facilitate the transfer of energy from the ytterbium to the erbium. However, doping with phosphorus reduces by approximately 10 nm the bandwidth within which erbium can be used for amplification, the gain then falling off below approximately 1535 nm; this constitutes a barrier in the C band and limits the use of the amplification range available with erbium.

### SUMMARY OF THE INVENTION

To be more precise, the invention proposes a C-band optical amplifier including a fiber with a monomode core, a multimode internal cladding and an external cladding, and means for pumping the fiber, wherein the fiber is not doped with ytterbium and the multimode cladding has a diameter less than 55 μm.

In one embodiment the multimode cladding has a diameter less than 35 μm.

The pumping means advantageously couple into the fiber light with 95% of its energy in a 978±10 nm band and preferably in a 978±3 nm band. Pumping can also be effected using light of which 95% of the energy is in a 1470±15 nm band and preferably in a 1470±10 nm band.

The multimode cladding can be circular, in which case the diameter of the monomode core is advantageously from 5 μm to 10 μm; also in the case of a circular cladding, the index difference between the monomode core and the multimode cladding is preferably from 5×10⁻³ nm to 15×10⁻³ nm.

In another embodiment the multimode cladding is not circular. In this case the diameter of the monomode core is advantageously from 3 μm to 10 μm; the index difference between the monomode core and the multimode cladding is preferably from 10×10⁻³ nm to 40×10⁻³ nm.

In either case the index difference between the multimode cladding and the outer cladding is advantageously from 10×10⁻³ nm to 150×10⁻³ nm.

The monomode core can be doped with a rare earth, such as erbium; the concentration by weight in the core can be from 100 ppm to 2000 ppm.

The invention also proposes a C-band wavelength division multiplex transmission system including an amplifier of the kind defined hereinabove.

Other features and advantages of the invention will become apparent on reading the following description of embodiments of the invention, which description is given by way of example and with reference to the accompanying drawings.

### BRIEF DESCRIPTION OF THE DRAWINGS

FIG. 1 shows the spectrum of a wavelength division multiplexed signal at the output of an amplifier according to the invention.

FIG. 2 is a graph of the gain of an amplifier according to the invention.

FIG. 3 is a graph of the gain of a prior art amplifier.

### DETAILED DESCRIPTION OF THE PREFERRED EMBODIMENT

The invention proposes using an optical fiber having a core, a multimode internal cladding and an outer cladding to amplify signals in the C band. Going against the prejudice in the art in favor of codoping with ytterbium, the invention proposes to use an optical fiber that is not codoped with ytterbium. It also proposes that the internal cladding of the fiber have a small diameter, and to be more precise a diameter less than 55 μm, or even less than 35 μm. The fact that the diameter of the multimode core is small improves the overlap between the pump modes and the signals transmitted in the core of the fiber and avoids the use of a codopant for transferring energy from the pump to the erbium ions.

The invention enables amplification in the C band; the absence of ytterbium and the associated phosphorus enables amplification across the whole of the amplification band of erbium, and even below 1535 nm.

References herein to the absence of ytterbium in the fiber refer to the absence of intentional doping with ytterbium. Ytterbium can be present in the fiber in trace amounts, or in low proportions. References herein to no ytterbium must therefore be understood as referring to a concentration by weight of ytterbium in the fiber less than 10 ppm. That concentration should be compared with the concentrations usually proposed for doping with ytterbium, which are of the order of 20 times the concentration of erbium.

The multimode cladding can have a conventional circular section; it can instead have a section with no symmetry of revolution but which is invariant on rotation through a given angle. Examples are a hexagonal section or a “rose-petal” section, i.e. a section having recesses distributed around the periphery of the multimode cladding; the fiber has longitudinal grooves. In this case, the external cladding is not of silica but instead of a material such as silicon or fluorinated polymer, and is added after drawing the optical fiber. This second solution has the advantage of further improving the overlap between the modes coupled into the multimode cladding and the signals transmitted in the core of the fiber. It also provides much more flexibility in terms of the choice of the indices of the core, the multimode cladding and the outer cladding.

Characteristics of the fiber will now be specified by way of example for a fiber with a step index change between the outer cladding and the multimode cladding and a step index change between the multimode cladding and the monomode core. If the multimode cladding is circular, the diameter of the monomode core can be from 5 μm to 10 μm; the diameter of the multimode cladding can be as much as 55 μm, as previously indicated. The index difference between the monomode core and the multimode cladding is advantageously from 5×10⁻³ nm to 15×10⁻³ nm. The index difference between the multimode cladding and the outer cladding is advantageously from 10×10⁻³ nm to 150×10⁻³ nm.

If the multimode cladding is not circular, an external cladding is used that is not made of silica and can more easily have an index lower than the index of silica; in this case, the diameter of the monomode core is previously from 3 μm to 10 μm and the index difference between the monomode core and the multimode cladding is advantageously from 10×10⁻³ nm to 40×10⁻³ nm. The index difference between the multimode cladding and the outer cladding is advantageously from 10×10⁻³ nm to 150×10⁻³ nm.

The amplifier according to the invention can be pumped using pumps centered on the absorption peaks of erbium; the fiber core can be doped with erbium in proportions by weight from 100 ppm to 2000 ppm; the multimode cladding is not doped with erbium. In the absence of a codopant capable of transferring energy from the pump to the ions, a pump is advantageously used around the absorption peak at 980 nm of which 95% of the energy is within a 978±10 nm band; a 978±3 nm band provides even more satisfactory results. Around the absorption peak at 1470 nm, a pump is preferably used with 95% of the energy in the 1470±15 nm band; it is even more advantageous for 95% of the energy to be in the 1470±10 nm band. Of course, one or more pumps in one or both bonds can be used for pumping in accordance with the invention.

Embodiments of the invention will now be described for a fiber having a monomode core 8.6 μm in diameter, with a step index change of 6.5×10⁻³ nm between the monomode core and the multimode cladding. The multimode cladding has a diameter of 50 μm and the step index change compared to the silica outer cladding is 11×10⁻³ nm. In this case, the monomode core is doped with erbium in a concentration of 1000 ppm and the monomode cladding is not doped with erbium. The fiber used for the amplifier referred to by way of example is 8 m long. A wavelength division multiplex signal with seven regularly spaced channels from 1529 nm to 1564 nm and an input power of −5.2 dBm is injected into the fiber. The signal is pumped by a pump centered at a wavelength of 980 nm, 95% of the energy from the pump lying within the band extending 4 nm either side of the center wavelength. The pump is a pump semiconductor diode using a technology similar to that of the SDLO-4200 diode from SDL (USA). It has a stripe width of 50 μm and is coupled into the amplifier fiber via a 50 μm diameter multimode fiber and a multiplexer. The pump has a transmit power of 5 W.

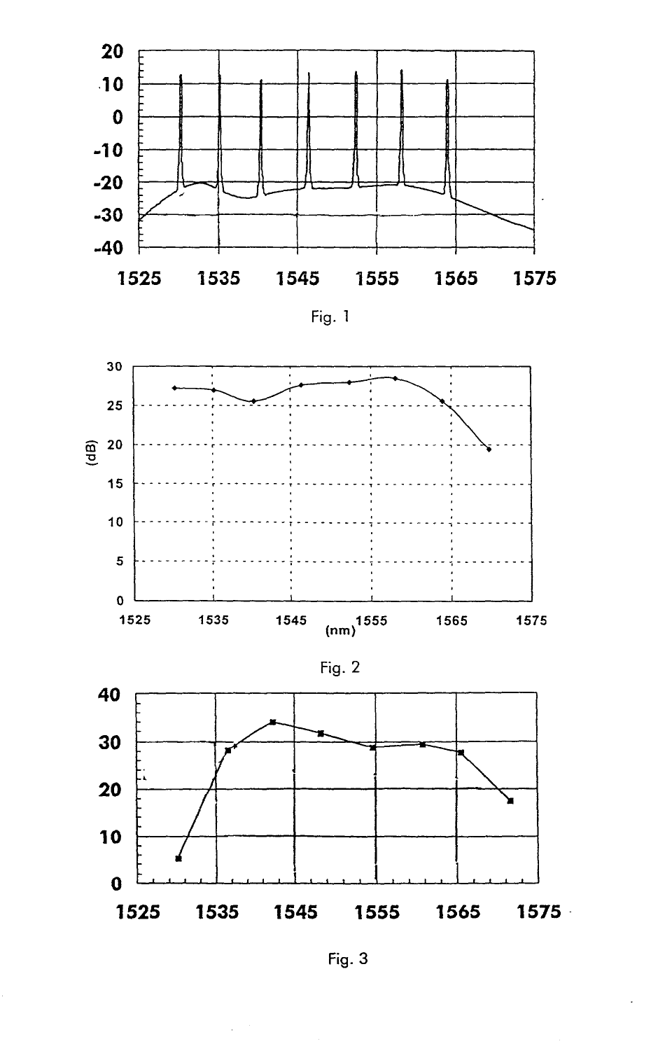

FIG. 1 shows the spectrum of the amplifier output signal; the wavelength in nm is plotted on the abscissa axis and the output power dBm on the ordinate axis; the seven peaks of the various channels, which have substantially the same power, can clearly be seen. The average output power is +22 dBm over the whole of the C band. FIG. 2 is a graph showing the gain of the amplifier in the C band; the wavelength is plotted on the abscissa axis and the gain dB on the ordinate axis. The figure shows that the gain remains substantially constant over the whole of the C band and in particular that the amplifier gain does not fall off below 1536 nm.

By way of comparison, FIG. 3 is a graph for the gain of a prior art multimode fiber amplifier codoped with ytterbium and phosphorus. The amplifier is EAD-X-C amplifier from IRE-POLUS, where X is a digit specifying the amplifier power in watts, from 1 W to 5 W. As shown in FIG. 3, the gain falls off below 1536 nm because of the presence of the phosphorus associated with the ytterbium. Accordingly, as can be seen by comparing FIGS. 2 and 3, the wanted band in the amplifier according to the invention extends approximately 10 nm farther down than the usable band of the prior art amplifiers used for the C band.

In the example of FIGS. 1 and 2, the average output power is +22 dBm over the whole of the C band for an input power of 0 dBm. For a fiber having a multimode cladding diameter of 30 μm, an output power of +24 dBm is obtained at the output of the amplifier, all other things being equal.

Of course, the invention is not limited to the preferred embodiments described above. It applies to pumps other than those indicated in the example. Rare earths other than erbium can also be used to obtain amplification. Finally, it will be clear to the skilled person that the fiber is doped, typically with germanium, so that the index can be varied to guide the light.

There is claimed:

1. A C-band optical amplifier including a fiber with a monomode core, a multimode internal cladding and an external cladding, and means for pumping said fiber, wherein said fiber is not doped with ytterbium and said multimode cladding has a diameter less than 55 μm.

2. The amplifier claimed in claim 1 wherein said multimode cladding has a diameter less than 35 μm.

3. The amplifier claimed in claim 1 wherein said pumping means couple into said fiber light with 95% of its energy in a 978±10 nm band and preferably in a 978±3 nm band.

4. The amplifier claimed in claim 1 wherein said pumping means couple into said fiber light of which 95% of the energy is in a 1470±15 nm band and preferably in a 1470±10 nm band.

5. The amplifier claimed in claim 1 wherein said multimode cladding is circular.

6. The amplifier claimed in claim 5 wherein the diameter of said monomode core is from 5 μm to 10 μm.

7. The amplifier claimed in claim 5 wherein the index difference between said monomode core and said multimode cladding is from 5×10⁻³ nm to 15×10⁻³ nm.

8. The amplifier claimed in claim 1 wherein said multimode cladding is not circular.

9. The amplifier claimed in claim 8 wherein the diameter of said monomode core is from 3 μm to 10 μm.

10. The amplifier claimed in claim 8 wherein the index difference between said monomode core and said multimode cladding is from 10×10⁻³ nm to 40×10⁻³ nm.

11. The amplifier claimed in claim 1 wherein the index difference between said multimode cladding and said outer cladding is from 10×10⁻³ nm to 150×10⁻³ nm.

12. The amplifier claimed in claim 1 wherein said monomode core is doped with a rare earth.

13. The amplifier claimed in claim 12 wherein said rare earth is erbium and is preferably present in the core in proportions by weight from 100 ppm to 2000 ppm.

14. A C-band wavelength division multiplex transmission system including a C-band optical amplifier including a fiber with a monomode core, a multimode internal
